(19) United States
(12) Patent Application Publication
(10) Pub. No.: US 2020/0363872 A1
(43) Pub. Date: Nov. 19, 2020

(54) HAPTIC FEEDBACK FOR TOUCH PANEL DEVICE

(71) Applicant: ZF Friedrichshafen AG, Friedrichshafen (DE)

(72) Inventors: Vitali FRIBUS, Quakenbrück (DE); Micharl PANTKE, Friedrichshafen (DE); Ludger RAKE, Steinfeld (DE)

(73) Assignee: ZF Friedrichshafen AG, Friedrichshafen (DE)

(21) Appl. No.: 16/643,435

(22) PCT Filed: Aug. 10, 2018
(86) PCT No.: PCT/EP2018/071751

§ 371 Date: Feb. 28, 2020

(30) Foreign Application Priority Data
Sep. 5, 2017 (DE) 10 2017 215 581.7

(51) Int. Cl. G06F 3/01; G06F 3/041

(52) U.S. Cl. CPC G06F 3/016; G06F 2203/04105; G06F 3/041

(57) ABSTRACT

The invention relates to a touch panel device comprising a touch input surface, at least one sensor that serves to monitor a contact and/or a load applied to the touch input surface, a tactile response generation unit that is rigidly connected to the touch input surface, and a control unit that serves to process a signal from the sensor and control the tactile response generation unit on the basis of the monitored contact and/or load, wherein the tactile response generation unit comprises a housing, said housing comprising magnetically conducting material, an electrically conducting coil arranged fixedly within the housing, and a core comprising magnetically conducting material, wherein the core is arranged within the coil, such that the core is movable along a long axis of the coil.

The invention relates to a touch panel device comprising a touch input surface, at least one sensor that serves to monitor a contact and/or a load applied to the touch input surface and a tactile response generation unit, for providing a haptic response to a user of the touch panel device.

Touch panel devices are increasingly ubiquitous, for example in the form of smart phones or control panels for household devices or vehicles. Touchscreens are often used with haptic response systems. A common example of this technology is the vibratory feedback provided when a button on the touchscreen is tapped. Haptics are used to improve the user's experience with touchscreens by providing simulated tactile feedback, and can be designed to react immediately, partly countering on-screen response latency.

The patent publications EP2461233B1 and U.S. Pat. No. 9,280,205B2 disclose methods and devices, respectively, for providing a ‘click’ sensation to a user of a touch panel device. According to EP2461233B1, such a ‘click’ sensation can be provided by vibrating the touch input surface at a certain frequency. U.S. Pat. No. 9,280,205B2 describes means for vibrating such a surface. Here, a voice coil is attached to the touch input surface and put into movement by providing a variable current to drive the coil. However, the solutions provided are unsatisfactory in terms of complexity, robustness and cost.

The object of the invention is therefore to introduce a touch panel device having a tactile response generation unit that is less complex, more robust, and less costly to produce and integrate into the device.

The object of the invention is achieved by a touch panel device according to the subject matter of the independent claim. The dependent claims and the description further describe advantageous embodiments of the touch panel device.

The object is therefore achieved by a touch panel device comprising a touch input surface, at least one sensor that serves to monitor a contact and/or a load applied to the touch input surface, a tactile response generation unit that is rigidly connected to the touch input surface, and a control unit that serves to process a signal from the sensor and control the tactile response generation unit on the basis of the monitored contact and/or load, wherein the tactile response generation unit comprises a housing, said housing comprising magnetically conducting material, an electrically conducting coil arranged fixedly within the housing, and a core comprising magnetically conducting material, wherein the core is arranged within the coil, such that the core is movable along a long axis of the coil. The housing is rigidly connected to the touch input surface. The connection is rigid in the sense that a force applied by the tactile response generation unit will be directly transferred to the touch input surface. The long axis of the coil extends through the center of the coil such that the loops of the coil encompass the long axis, wherein the long axis is essentially perpendicular to a surface defined by a single loop of the coil. Magnetically conducting in the sense of the invention is material that has a relative permeability of more than 40, preferably more than 400, very preferably more than 4000. The housing can completely or partially enclose the coil. A guide element can be provided to guide the movement of the core within the coil. The control unit can be a microcontroller for example.

A device with a tactile response generation unit of this sort is very robust as the only moving part is the core, which can be a cylinder, in particular of iron, for example. In particular, the core moves with respect to the housing and with respect to the touch input surface. This movement creates an impulse that is carried from the housing to the surface, thereby providing haptic, i.e. tactile, feedback for a user.

The housing which comprises a magnetically conducting material exhibits negligible inductivity because it can be embodied as an open circuit, made of iron for example. This reduces electromagnetic interference effects of the unit within the device, and therefore permits more flexibility while integrating the unit in the device. This can lower production costs. The components of the unit are also generally less expensive than the components of conventional haptic feedback units. The reduced complexity of the unit in comparison to conventional haptic feedback units also permits a simple integration of the unit into the device.

In general, the integration of such a tactile response generation unit in a touch panel device can reduce users input errors, increase input speed, and lower their cognitive load when touch panel devices are combined with haptics or tactile feedback in comparison with non-haptic touch panel devices.

In an embodiment of the touch panel device the control unit is embodied to initiate a current in the coil such that when the magnetically conducting portion of the core is asymmetrically positioned with respect to the coil, the core begins an oscillating movement with respect to the coil. Asymmetric in the sense of the invention means that a middle point, with respect to the long axis, of the magnetically conducting portion of the core does not align with a middle point of the coil with respect to the long axis.

Depending on the mass of the core, the strength of the coil, and the magnitude of the current applied to the coil, the oscillation of the core can cause a vibration on the touch input surface in the frequency range of 50 to 300 Hz. Depending on the rigidity, i.e. stiffness, of the connection between the housing of the tactile response generation unit and the touch input surface, the amplitude of the vibration on the surface will be 0.1 mm at a maximum, and will generally be damped to around 5% of the maximum after three cycles. The acceleration to the first vibration peak of the touch input surface can be ca. 6 G.

With these characteristics it is possible for a tactile response generation unit of this sort to simulate a short keystroke for a user by stimulating the Pacini-receptors in the fingertips of the user.

In an embodiment of the touch panel device the core comprises a material having a lower relative permeability than the magnetically conducting material comprised in the core. It is thereby possible to increase the mass of the core, providing more flexibility in the embodiment of the tactile response generation unit. The increased mass can lead to an increased impulse, and increased vibration. Advantageously, a cost-efficient material can be used for this purpose.

In an embodiment of the touch panel device a spring mechanism is provided, said spring mechanism being attached to the housing and/or coil and serving to apply a spring force to the core such that the core returns to an initial position when the current applied to the coil is set to zero. When the unit is integrated into a mobile touch panel device, this can be particularly advantageous because the mobile device may be oriented in any direction with respect to the local gravitational force at any given time. In a control panel in a motor vehicle, the weight of the core will generally be enough to return the core to an initial position when no current is applied to the coil. In order to ensure that the coil returns to the same initial position, an end stop element that is attached to the housing or the coil can be provided. The initial position of the core, along with the respective masses of the components of the unit, permeabilities of the magnetically conducting components, coil strength and current strength, regulates the initial impulse created by the core when current is applied to the coil. It is therefore advantageous to return the coil to an initial position, when the tactile response generation unit is inactive, to achieve the same haptic feedback when applying the same current.

In an embodiment of the touch panel device the tactile response generation unit is embodied to prevent the core from coming into direct contact with the touch input surface. For example, the housing can comprise a wall or hook that serves as an end stop for the core. In some conventional haptic feedback systems, a moving part of a haptic feedback generation unit comes into direct contact with the touch input surface. Such systems have failed to simulate a short stroke key for users of the touch panel devices. Since the core is free to move along the long axis, it is advantageous to provide an element that prevents movement of the core in the direction of the touch input surface, thereby preventing contact between the core and the surface.

In an embodiment of the touch panel device the rigid connection between the tactile response generation unit and the touch input surface is embodied to transfer a mechanical vibration caused by the oscillating movement of the tactile response generation unit to the touch input surface. The connection can, for example, comprise portions of the touch input surface that extend in a direction perpendicular to the surface towards the tactile response, i.e. feedback, generation unit. The tactile response generation unit can then be fixed to these extending portions.

In an embodiment of the touch panel device the touch panel device comprises a device housing, wherein the touch input surface is elastically connected to the device housing. The touch input surface should be movably connected to the housing of the device so that the movement of the touch input surface caused by the tactile feedback device is not damped externally.

In an embodiment of the touch panel device the connection between the device housing and the touch input surface comprises a damping element. The elastic connection can comprise damping pads, for example, positioned between the touch input surface and the device housing. These damping pads can permit the touch input surface to move with respect to the device housing, and can also serve to apply the appropriate damping to the touch input surface when the tactile feedback generation unit is activated.

In an embodiment of the touch panel device the sensor for monitoring the load applied to the touch input surface is arranged between touch input surface and a wall of the device housing.

In an embodiment of the touch panel device the signal from the sensor comprises information regarding the location of the contact on the touch input surface, and wherein the control unit is embodied to determine a magnitude of separation between the location of the contact and the tactile response generation unit and/or between the location of the contact and the rigid connection that connects the tactile response generation unit to the touch input surface, and wherein the control device controls the tactile response generation unit on the basis of the determined magnitude of separation. The tactile response generation unit creates an oscillating impulse that is carried over the rigid connection to the touch input surface. The oscillation is therefore greatest on the area of the touch input surface bordering the connection point. In order to provide the identical vibrational tactile feedback at each position on the surface of the touch input surface, the impulse supplied to the surface should be varied on the basis of the distance of the contact from this connection point. The control unit should therefore be embodied to calculate the magnitude of the distance of the contact from the connection point, and control the current applied to the coil accordingly.

Certain embodiments of the invention will next be explained in detail with reference to the following figures. They show:

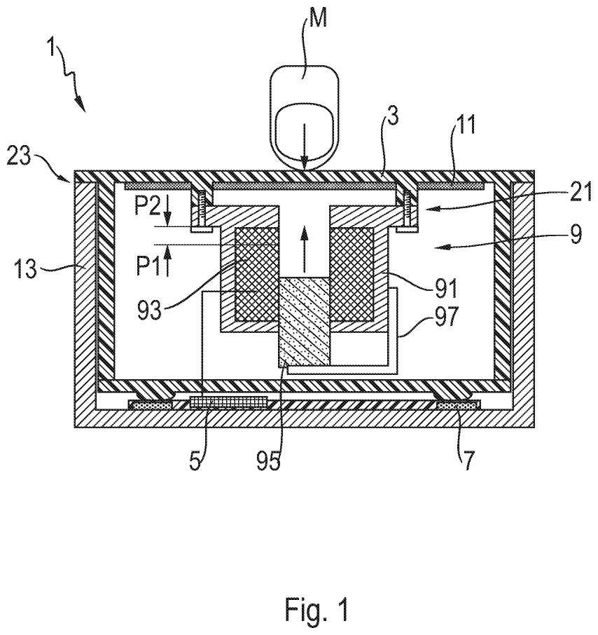

FIG. 1: a schematic representation of the input panel device to according an embodiment of the invention in an inactivated state; and

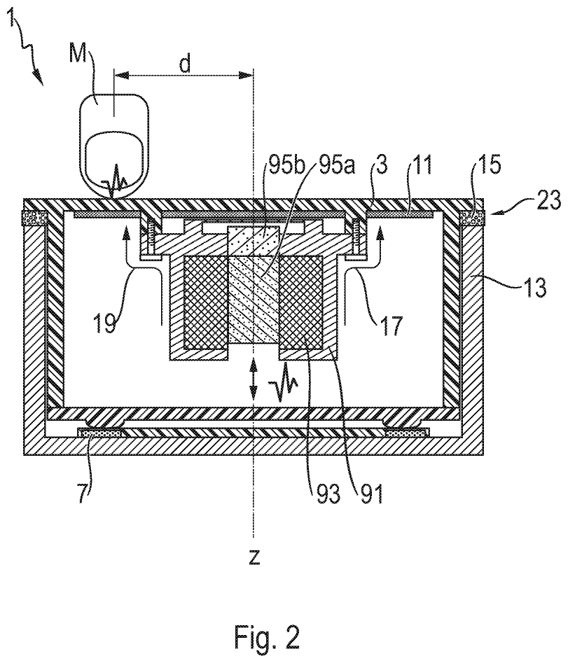

FIG. 2: a schematic representation of the input panel device according to an embodiment of the invention in an activated state.

FIG. 1 shows a schematic representation of the input panel device 1 to according an embodiment of the invention in an inactivated state. Shown is an input panel device 1 with an input touch surface 3, a control unit 5, a sensor for monitoring load 7, a touch substrate for monitoring contact 11, a tactile feedback generation unit 9, and a device housing 13. The tactile feedback generation unit 9 comprises a housing 9, a coil 93, a core 95, and an end stop for the core 97. The touch panel device is fixedly positioned in a control panel for a vehicle. The core 95 is in an initial position P1, resting on the support element i.e. end stop 97. There is no current flowing in the coil 93. The core 95 is movable with respect to the coil 93 along the long axis Z of the coil.

The tactile response generation unit 9 is rigidly attached to the touch input surface 3. The connection 21 comprises portions of the touch input surface 3, which extend towards the tactile response generation unit 9. The unit 9 is screwed or bolted to the extending portions of the surface 3, thereby fixing the unit 9 in place with respect to the surface 3.

A user M is contacting the touch input surface 3, applying a certain amount of pressure. The pressure sensor 7 is monitoring the pressure applied to the surface. The control unit 5 is arranged on a printed circuit board PCB along with the pressure sensor 7, and is connected to the pressure sensor 7 via a communications pathway. When the applied pressure exceeds a predetermined threshold, the control unit 5 will initial a current in the coil 93. The current in the coil 93 generates a magnetic field. The magnetic field is guided by the magnetically conducting portions of the housing 91. This concentration of the magnetic field generates reluctance forces which act on the core 95 and cause it to initially be accelerated in the direction of the touch input surface 3. When a middle point of the magnetically conducting portion of the core 95 passes the middle point of the coil 93, the reluctance forces act on the core 95 in the opposite direction, accelerating in a direction facing away from the touch input surface 3. The system works analogously to a spring mass system, and the movement of the core 95 can be characterized as a damped sinewave, wherein the core 95 eventually settles at a final position P2.

The interaction between the core 95 and housing 91 of the tactile response generation unit 9 due to the magnetic field generated by the coil 93 and guided by the housing 91 results in a mechanical vibration, which is transferred to the touch input surface 3 via the rigid connection. The vibration is experienced by the user M of the touch panel device 1 as a short keystroke, i.e. the user experiences a ‘click’ sensation.

FIG. 2 shows a schematic representation of the input panel device 1 according to an embodiment of the invention in an activated state. A current is being applied to the coil 93. The coil 93 is generating a magnetic field which flows through the housing 91 of the tactile response generation unit 9 and attempts to short circuit across the core 95 to complete a magnetic circuit. The core 95, which comprises a magnetically conducting portion 95a and non-magnetically conducting portion 95b, has been accelerated past this equilibrium point. The portion of the core 95b that has a smaller relative permeability than the magnetically conduction portion 95a adds mass to core 95 such that the momentum of the core 95 in motion is increased. This causes the core 95 to accelerate past the equilibrium point farther than it would otherwise, and exposes the touch input surface 3 to a larger impulse than it would otherwise be exposed to. The mechanical forces caused by the movement of the core 95 within the coil 93 are carried to touch input surface 3 along the pathways indicated by the arrows 17, 19.

The reluctance forces from the magnetic field cause the core 95 to oscillate along the long axis Z. The touch input surface 3 vibrates, simulating a short keystroke of less than 1 mm.

In the embodiment shown in FIG. 2, the distance d separating the point of contact from the connection point, i.e. where the long axis of the tactile feedback generation unit 9 intersects the surface, is determined. On the basis of the magnitude of separation d, the strength of the current to be applied to the coil 93 is determined, such that the vibration experienced by the user is identical regardless of where on the input surface contact 3 is made.

Damping elements 15 are provided in the connection between the touch input surface 3 and the housing of the touch panel device 1.

### REFERENCE CHARACTERS

1 Input panel device
3 touch input surface
5 control unit
7 sensor
9 tactile response generation unit
91 housing of tactile response generation unit
93 coil
95 core
95a,b magnetically conductible, less permeable material of core
97 support element/end stop
11 touch substrate for sensing contact
13 housing of touch panel device
15 damping material
17 force pathway arrow
19 force pathway arrow
21 connection between unit and touch input surface
23 connection between surface and housing of device
P1 initial position
P2 final/equilibrium position when device is energized
Z long axis
d distance from contact to feedback generation unit
M user

1. A touch panel device comprising:
a touch input surface;
at least one sensor that serves to monitor at least one of a contact or a load applied to the touch input surface;
a tactile response generation unit that is rigidly connected to the touch input surface; and
a control unit configured to process a signal from the sensor and to control the tactile response generation unit on a basis of the at least one of the monitored contact or the monitored load,
wherein the tactile response generation unit comprises;
a housing, said housing comprising magnetically conducting material;
an electrically conducting coil arranged fixedly within the housing; and
a core comprising magnetically conducting material, wherein the core is arranged within the coil, such that the core is movable along a long axis of the coil.

2. The touch panel device according to claim 1, wherein the control unit is configured to initiate a current in the coil such that when a magnetically conducting portion of the core is asymmetrically positioned with respect to the coil, the core begins an oscillating movement with respect to the coil.

3. The touch panel device according to claim 1, wherein the core comprises a material having a lower relative permeability than a magnetically conducting material comprised in the core.

4. The touch panel device according to claim 1, further comprising:
a spring mechanism attached to at least one of the housing or the coil and configured to apply a spring force to the core such that the core returns to an initial position when a current applied to the coil is set to zero.

5. The touch panel device according to at claim 1, wherein the tactile response generation unit is configured to prevent the core from coming into direct contact with the touch input surface.

6. The touch panel device according to at claim 1, wherein the rigid connection between the tactile response generation unit and the touch input surface is configured to transfer a mechanical vibration caused by an oscillating movement of the tactile response generation unit to the touch input surface.

7. The touch panel device according to claim 1, further comprising a device housing, wherein the touch input surface is elastically connected to the device housing.

8. The touch panel device according to claim 7, wherein the connection between the device housing and the touch input surface comprises a damping element.

9. The touch panel device according to claim 1, wherein the sensor for monitoring the load applied to the touch input surface is arranged between the touch input surface and a wall of a device housing.

10. The touch panel device according to claim 1, wherein the signal from the sensor comprises information regarding a location of the contact on the touch input surface, and wherein the control unit is configured to determine a magnitude of separation between the location of the contact and at least one of the tactile response generation unit or the rigid connection that connects the tactile response generation unit to the touch input surface, and wherein the control unit controls the tactile response generation unit on a basis of the determined magnitude of separation.
